(19) United States
(12) Patent Application Publication
(10) Pub. No.: US 2021/0114031 A1
(43) Pub. Date: Apr. 22, 2021

(54) Microfluidic Device and Method for the Operation Thereof

(71) Applicant: Robert Bosch GmbH, Stuttgard (DE)

(72) Inventor: Tino Frank, Luzern (CH)

(21) Appl. No.: 16/961,803

(22) PCT Filed: Dec. 19, 2018
(86) PCT No.: PCT/EP2018/085927

§ 371 Date: Jul. 13, 2020

(30) Foreign Application Priority Data
Jan. 15, 2018 (DE) 10 2018 200 518.4

(51) Int. Cl. B01L 3/00

(52) U.S. Cl. CPC B01L 3/502769; B01L 2200/0673; B01L 2200/0684; B01L 2400/0481; B01L 2200/16

(57) ABSTRACT

The disclosure relates to a method for operating a microfluidic device that includes providing at least one first medium at a first location of the microfluidic device, transporting at least one first medium from a first location to a second location of the microfluidic device, the at least one first medium being surrounded by at least one second medium in such a way that the at least one first medium only borders on the at least one second medium and on fluid boundaries of the microfluidic device or only on the at least one second medium. The at least one first medium and the at least one second medium cannot be mixed with one another.

### PRIOR ART

Microfluidic systems allow the analysis of small sample quantities with a high level of sensitivity. At the same time, automation, miniaturization and parallelization of methods allow a reduction of manual steps and can therefore contribute to avoiding errors. Moreover, miniaturization by microfluidic systems makes it possible to carry out laboratory processes directly with the sample, meaning that there is no need for a general laboratory environment Instead, a process can be reduced to a fluidic chip. Therefore, microfluidic applications can also be referred to as “lab-on-chip”. This field of use of microfluidics is also referred to as “point-of-care (PoC)”.

A challenge in the case of microfluidic systems is especially the transfer of macroscopic samples into the microfluidic environment.

### DISCLOSURE OF THE INVENTION

What are presented here are a particularly advantageous method for operating a microfluidic device and also a microfluidic device for said method. The dependent claims specify particularly advantageous further developments of the method.

By means of the described method, microfluidically limited sample solutions in particular can be moved in a microfluidic device having a microfluidic chamber-and-channel system without any losses. In particular, by means of the described method, a limited sample (e.g., cell lysate of a few cells, cfDNA material, cytokine enrichment) can be transferred from a sample input chamber into a chamber for carrying out a detection method (e.g., PCR) without any bubbles and losses.

As a result of an addition of sample, rare material (e.g., cell-free DNA, circulating cancer cells, secreted cytokines, lysate of a few cells) can be enriched in a small volume of a microfluidic device and therefore be initially charged in a high concentration. In the described method, this sample input chamber need not be at the same site of the microfluidic device at which an evaluation and/or further processing also take place. Instead, the sample can be transported within the microfluidic device by means of the described method. In the prior art, such transport often occurs by laminar flow in an aqueous solution. However, this can result in material depositing on the channel walls or being diluted by more liquid or diffusion. Furthermore, air can get into the system because of a contact area to the outside world and/or because of a lack of possibility to prewet the chamber, and this can lead to disruptive bubbles for subsequent processes.

The term “microfluidic” refers here especially to the scale of the microfluidic device. The microfluidic device is characterized in that physical phenomena generally classified under microtechnology are relevant in the fluidic channels and chambers arranged therein. These include, for example, capillary effects, effects (especially mechanical effects) associated with surface tensions of the fluid. These additionally include effects such as thermophoresis and electrophoresis. In microfluidics, said phenomena are usually dominant over effects such as gravity. The microfluidic device can also be characterized in that it is produced at least in part using a layer-by-layer method and channels are arranged between layers of the layer structure. The term “microfluidic” can also be characterized via the cross-sections within the device that serve for guiding the fluid. For example, cross-sections are usually in the range from 100 μm [micrometers]×100 μm right up to 800 μm×800 μm. Distinctly smaller cross-sections, for example in the range from 1 μm to 20 μm [micrometers], especially in the range from 3 μm to 10 μm, are possible too.

The microfluidic device can be especially a so-called “lab on a chip” or a “point-of-care” system (PoC). Such a “lab on a chip” is intended and configured for carrying out biochemical processes. This means that functionalities of a macroscopic laboratory are integrated into a plastic substrate for example. The microfluidic device can, for example, comprise channels, reaction chambers, pre-stored reagents, valves, pumps and/or actuation, detection and control units. The microfluidic device can make it possible to process biochemical processes in a fully automatic manner. This means that it is, for example, possible to carry out assays on liquid samples. Such assays can, for example, be used in medicine. The microfluidic device can also be referred to as a microfluidic cartridge. Especially by inputting samples into the microfluidic device is it possible to carry out biochemical processes in the microfluidic device. At the same time, it is also possible for additional substances which trigger, quicken and/or allow biochemical reactions to be admixed with the samples.

By means of the described method, especially a first medium can be transported from a first site of the microfluidic device to a second site of the microfluidic device.

In step a) of the described method, at least one first medium is provided at a first site of the microfluidic device.

The first medium is preferably a liquid, especially an aqueous solution. In particular, the first medium can be a sample to be tested.

“Providing” is to be understood here to mean especially that the at least one first medium is brought to the first site of the microfluidic device, for example by filling the at least one first medium through an opening into the microfluidic device. However, what is also encompassed by “providing” is, for example, that the microfluidic device already contained the at least one first medium before the start of the described method. For example, a microfluidic device in which the at least one first medium is already pre-stored in a chamber can be purchased from a supplier. It is also possible that, by adding multiple substances together in step a), the at least one first medium is obtained and, in this respect, provided. For example, a solvent can be pre-stored in the microfluidic device. Upon addition of a sample to the microfluidic device, the sample can be admixed with the solvent. The solution of the sample in the solvent can be the first medium.

In step b) of the described method, the at least one first medium is transported from the first site to a second site of the microfluidic device. In this case, the at least one first medium is surrounded by at least one second medium such that the at least one first medium is adjacent only to the at least one second medium and to fluid boundaries of the microfluidic device or only to the at least one second medium. The at least one first medium and the at least one second medium are not miscible with one another.

In step b), the first medium is transported through the microfluidic device. In this case, the at least one first medium can be particularly easily protected. Especially to this end, the at least one first medium is preferably surrounded by the at least one second medium such that the at least one first medium is adjacent only to the at least one second medium and optionally additionally to fluid boundaries of the microfluidic device.

What is possible here as a fluid boundary is especially any wall of the microfluidic device that, for example, delimits a channel or a chamber of the microfluidic device. Within the microfluidic device, media such as the at least one first medium and the at least one second medium can be present and moved especially within the fluid boundaries. The fluid boundaries can comprise especially a material such as plastic and/or glass at the fluid to be delimited.

In step b), the at least one first medium can especially be protected from coming into contact with other substances. This can be achieved by the at least one first medium, where it is not in contact with a fluid boundary, only being in contact with the at least one second medium. Because the at least one first medium and the at least one second medium are not miscible with one another, the at least one first medium can be transported without change owing to contact with the second medium. The at least one second medium can especially be understood as an aid for transport of the at least one first medium. After transport, the at least one first medium and the at least one second medium can be separated from one another.

The at least one second medium is preferably an oil. It is also preferred that the at least one second medium is an organic substance. In particular, it is preferred that the at least one first medium is polar and the at least one second medium is nonpolar. For example, with water as first medium and oil as second medium, this is the case. As aqueous solution, water admixed with classic attributes such as Tween, Triton-X, BSA and/or calcium can be used for the first medium. As possible second media, inert mineral oils, silicone oils and/or fluorinated oils can be used in particular. Preference is given to dispensing with the use of surfactants.

By means of the described method, especially a defined volume of an aqueous phase (as the at least one first medium) can be enclosed in an oil phase (as the at least one second medium) and moved in a controlled manner. For example, in this case, an analyte situated in the aqueous phase can be present in a limited, small quantity and be processed in the microfluidic device without any losses and without any dilution.

Owing to the use of the at least one second medium (especially an organic phase), the at least one first medium (especially an aqueous volume) can be enclosed such that, for example, a limited analyte in the at least one first medium is not diluted by deposition or diffusion. What is therefore possible is especially transport of limited sample materials (as first medium) without any losses. For example, a lysate generated locally in a microfluidically small volume from a few cells can be transported from an input chamber to another site in the microfluidic device in order to process it biochemically.

The transport of limited material such as DNA, proteins and/or individual cells without any losses can allow a microfluidic processing unit design in which, for example, a heater or optical units are envisaged at a site other than a sample input site. This can allow a particularly universal design of the microfluidic device.

Furthermore, fluid boundaries (i.e., especially channel walls and/or chamber walls) can be wetted by a first filling of the microfluidic device with the at least one second medium. In this case, a thin layer of the second medium can deposit on the fluid boundaries. Said thin layer can, for example in the case of polycarbonate as material of the fluid boundary, have the advantage that no DNA is bound to the polycarbonate (or to the layer of the second medium). This can contribute to transport of DNA in the at least one first medium without any losses.

The microfluidic device preferably comprise a one-way flow system which allows a diagnosis depending on the nature of the point-of-care. The components of the microfluidic device can, in this case, be made in a polycarbonate injection-molded part.

In a preferred embodiment of the method, a specifiable volume of the at least one first medium is provided in a chamber of the microfluidic device in step a), wherein the chamber has at least one port, and wherein the specifiable volume of the at least one first medium in the chamber is separated and measured off by the at least one second medium outside the chamber flowing around the at least one port.

The at least one first medium can be especially a sample to be analyzed. Especially in such a case, it may be advantageous to use an exactly defined quantity (especially an exactly defined volume) of the at least one first medium, for example for an analysis. To obtain such an exactly defined quantity of the at least one first medium, the desired quantity of the at least one first medium can be separated and measured off as per the present embodiment. For instance, especially the chamber of the microfluidic device that is considered in this embodiment can be filled with the at least one first medium especially via the at least one port. When the chamber is completely filled with the at least one first medium, the volume of the at least one first medium corresponds to the (preferably known) volume of the chamber. However, a delimitation between the volume within the chamber and outside the chamber may be problematic especially in the region of the at least one port. For instance, it may be unclear where exactly the boundary of the chamber passes through the at least one port. In the present embodiment, said boundary can be defined by the at least one second medium. Preferably, the at least one port is designed such that a flow of the at least one second medium flows around the at least one port in a reproducible manner (with preferably defined parameters such as, for example, a flow velocity). In the case of such a reproducible around-flow, what arises is an interface between the at least one first medium and the at least one second medium that is situated especially in the region of the at least one port. By means of this boundary, it is possible to clearly define the volume of the chamber.

In a further preferred embodiment of the method, multiple first media are provided in step a), wherein the multiple first media are transported as per step b) such that the multiple first media are mixed in a chamber of the microfluidic device.

In particular, the multiple first media can be components of a substance to be analyzed. In this case, the multiple first media can, for example, remain separated from one another until an analysis is to be carried out. For example, a reaction between the multiple first media can be prevented up until performance of the analysis.

The two-phase technology (in which the at least one first medium and the at least one second medium are used) can especially be used for mixing two limited sample volumes or fluids (as the multiple first media). The two preferably aqueous volumes of the first media can be guided to a chamber without any losses and be mixed there by means of diffusion. Such mixing can especially take place sufficiently rapidly when the volumes to be mixed are sufficiently small.

In a further preferred embodiment of the method, at least one portion of the at least one first medium and/or at least one portion of the at least one second medium are transported at least intermittently by peristaltic pumping in step b).

Peristaltic pumping is to be understood here to mean a pump which conveys a liquid with the aid of peristalsis. A typical peristaltic pump is a hose pump, also called a constriction-hose pump. Peristaltic pumps are displacement pumps in which the medium to be conveyed is pushed through a channel by an external mechanical deformation. Microfluidic peristaltic pumps can be built up from a plurality of valves. Commonly used microfluidic valves comprise a channel which is closable by a movement of the channel wall as a consequence of an electrical force or a magnetic force. Such valves generate an (internal) change in volume of the channel. When such valves are arranged in a series connection along a channel, an appropriate control of the valves can achieve the occurrence of peristalsis in the channel, which brings about conveyance of the liquid. By opening and closing the valves, what occur are changes in the volume of a channel that achieve transport of a medium through the channel of the microfluidic device. A peristaltic pump has the advantage that no (other) pumping elements are required therefor besides the valves (e.g., mechanically or electrically operating pump chambers). It is sufficient to envisage the plurality of valves. For peristaltic pumping, it is preferred that there is the option of (automatic) valve switching, which controls the valves in an automated manner in an order suitable for conveyance.

Combining fixed channel geometries with on-chip pumps can allow a dynamic setting of volumes. This is particularly easily possible especially in a two-phase system (comprising the at least one first medium and the at least one second medium). If, by contrast, only an aqueous phase were to be envisaged for example (i.e., only the at least one first medium for example), the volumes would be specified by fixed geometries of the chambers. With a two-phase system by contrast, the chamber geometry forms only an upper boundary of the possible volume. Since an aqueous and an oil phase do not mix, the inert oil can compensate for the volume not required by the aqueous phase. This can allow an additional dynamic component and an adjustment of volumes within the microfluidic device.

In a further preferred embodiment, the method further comprises at least the following method step, which is carried out before, during or after step b):
c) removing at least one gas pocket.

Gas pockets may be present in the microfluidic device especially in the form of gas bubbles. Gas pockets can be especially disadvantageous because they mean that volumes can only be inexactly defined and/or because reactions can occur between the gas and especially the at least one first medium. In the present embodiment, gas pockets can be removed. The gas can be especially air. The gas can also be a product of chemical reactions.

The at least one gas pocket can be removed especially by transport of a medium. For instance, especially a medium surrounding the at least one gas pocket can be moved through the microfluidic device such that the at least one gas pocket arrives at one site of the microfluidic device at which an upwardly directed flow path (contrary to the direction of gravity) is accessible for the at least one gas pocket for escape of the gas.

The at least one gas pocket can especially be removed insofar that the gas is conducted out of the microfluidic device or that the gas is conducted at least from one part of the microfluidic device into another part of the microfluidic device, the gas being less damaging or disruptive in the latter part.

The at least one gas pocket can, however, also be removed by removing a gas dissolved in the at least one first medium (i.e., a substance which is in gaseous form under standard conditions) from the at least one first medium. For instance, a two-phase system (comprising the at least one first medium and the at least one second medium) can particularly easily allow a degassing of the microfluidic device because many oils (which are preferably used as the at least one second medium) have a higher gas solubility than water (which is preferably used as an essential component of the at least one first medium). Therefore, what can be achieved is that gases dissolved in water pass into the gas phase and are subsequently redissolved in the oil. In this respect, a gas pocket can also be removed by a quasi-phase extraction.

Removing the at least one gas pocket can be achieved especially in the preferred embodiments of the method in which the microfluidic device is, at least during part of step c), oriented such that one side of a section from which the at least one gas pocket is removed is tilted with respect to a horizontal plane.

Preferably, the microfluidic device is, over the entire step c), oriented such that one side of a section from which the at least one gas pocket is removed is tilted with respect to a horizontal plane. Preferably, the microfluidic device is oriented such that the side of the section from which the at least one gas pocket is removed is tilted by an angle in the range from 20° to 45°, especially 30°, with respect to the horizontal plane.

By tilting the microfluidic device, what can be achieved is that the gas can escape upward (i.e., against the direction of gravity) from the at least one gas pocket.

In a further preferred embodiment of the method, a temperature of a fluid in which the at least one gas pocket is enclosed is changed in step c).

As a result of the temperature change, a solubility of the gas in the fluid can be reduced, with the result that the gas can escape more easily from the gas pocket.

In a further preferred embodiment of the method, the at least one gas pocket is removed by transport of the at least one first medium and/or the at least one second medium in step c).

In particular, using the at least one first medium and/or the at least one second medium to remove the at least one gas pocket may be advantageous insofar that the at least one first medium and/or the at least one second medium are present anyway in the microfluidic device and/or that these mediums are moved anyway by the described method.

In a further preferred embodiment of the method, a shuttle polymerase chain reaction [shuttle PCR] is carried out, wherein the at least one first medium is a reaction medium of the shuttle polymerase chain reaction.

A PCR is a method for reproducing DNA, in which the enzyme DNA polymerase is used. A PCR can take place especially under a change in the temperature of the reaction medium. In the case of a shuttle PCR, said temperature is changed by transporting the reaction medium between sites of different temperature (especially between chambers of different temperature). A temperature change can thus be achieved particularly rapidly.

The described method can especially give rise to the advantage that a shuttle PCR can be carried out in a defined manner, without any bubbles and without any losses. By contrast, in a one-phase system, there would be the risk that residues of the reaction medium remain in a channel and/or air might get into the reaction chamber.

As a further aspect, what is presented is a microfluidic device which is intended and configured for carrying out the described method.

The particular advantages and design features of the method that are described further above are applicable and transferable to the described microfluidic device.

Further details of the invention and exemplary embodiments, to which the invention is not restricted however, will be more particularly elucidated on the basis of the drawings, where:

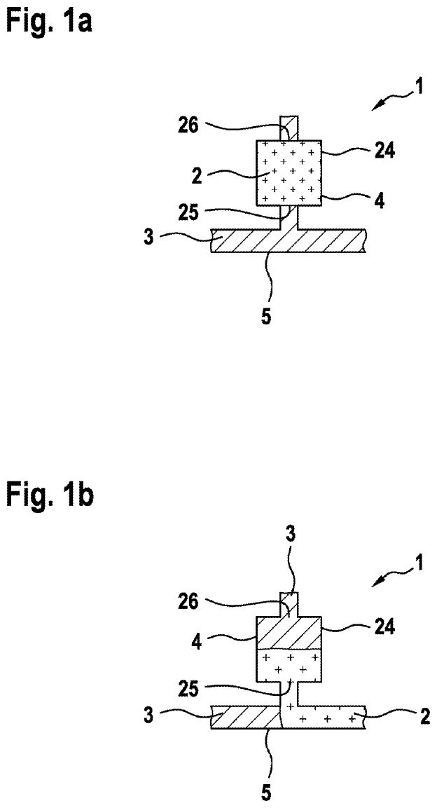

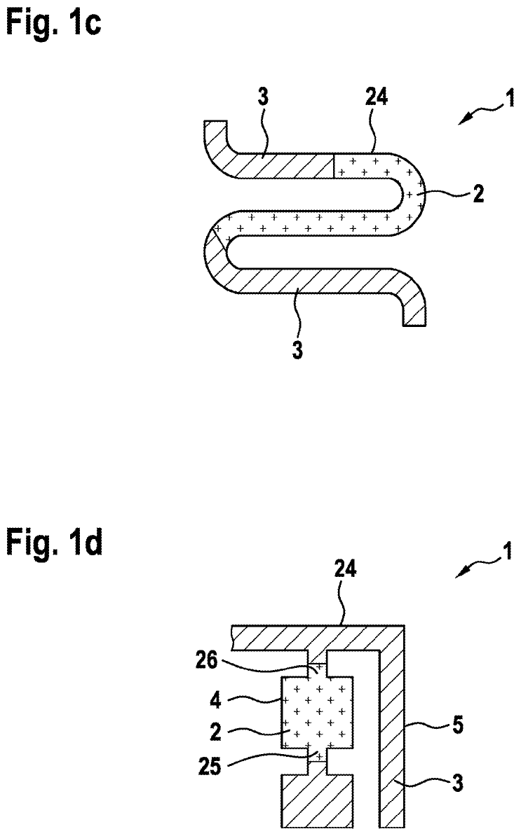

FIGS. 1a to 1d: show four schematic representations of microfluidic devices having a first medium and a second medium

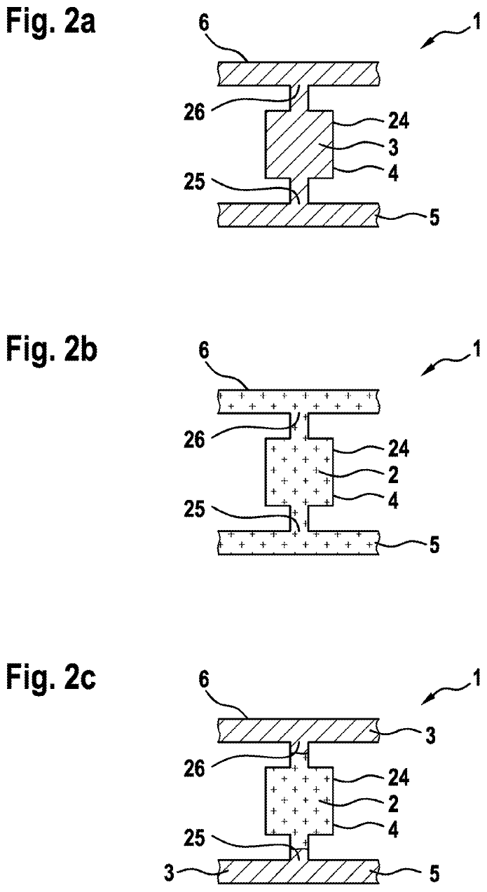

FIGS. 2a to 2c: show schematic representations of a microfluidic device in three successive points in time, wherein a volume of a first medium is separated and measured off,

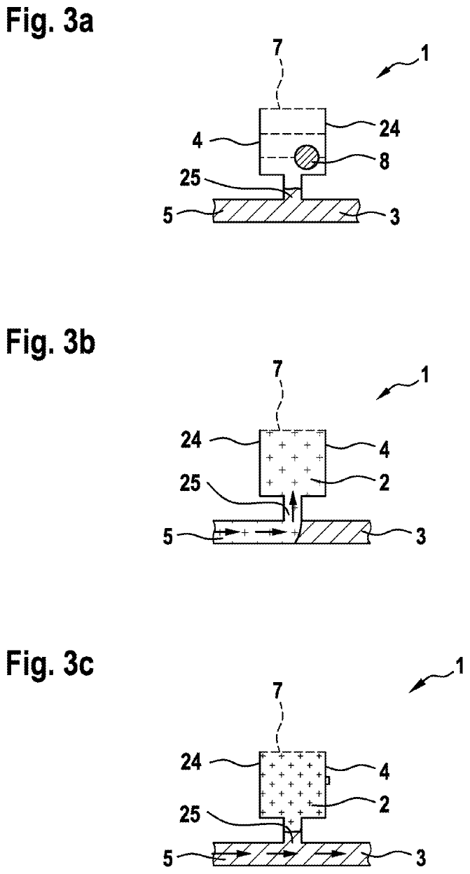

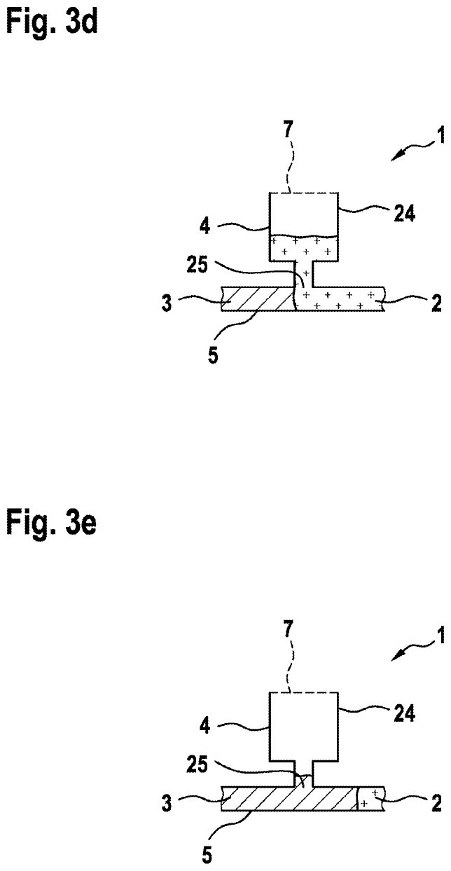

FIGS. 3a to 3e: show schematic representations of a microfluidic device in five successive points in time, wherein a first medium is generated and a volume of the first medium is separated, measured off and transported away,

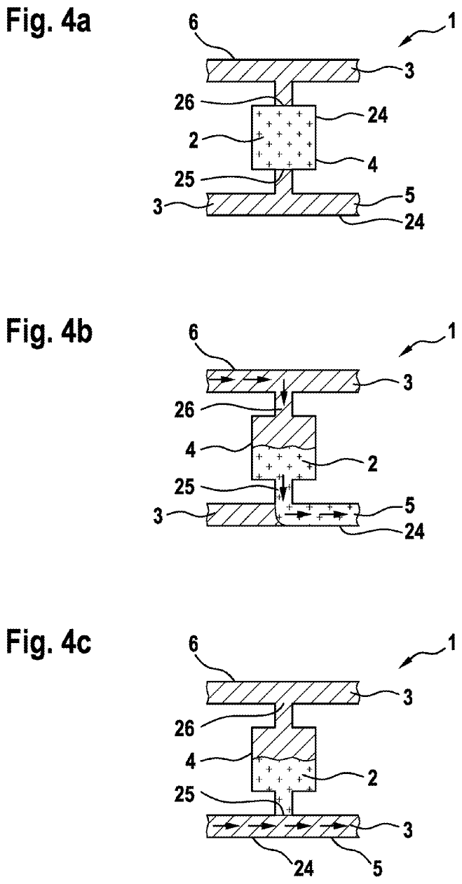

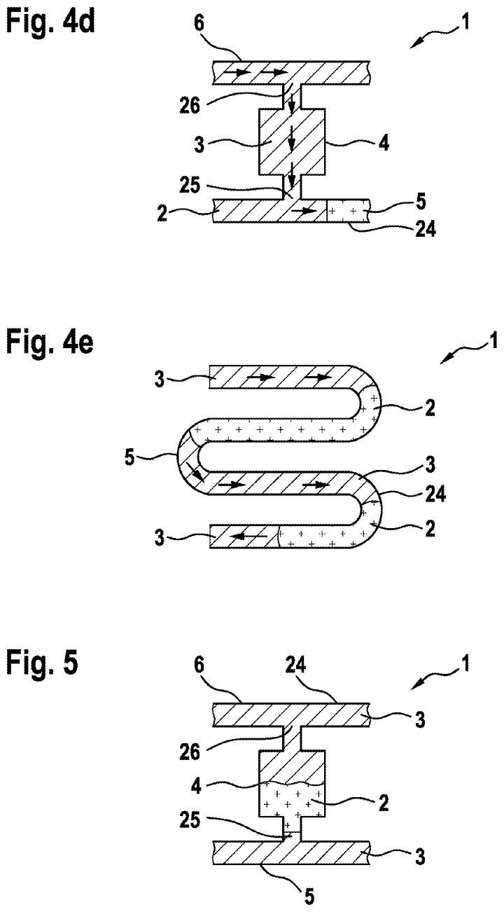

FIGS. 4a to 4e: show schematic representations of a microfluidic device in five successive points in time, wherein a first medium is separated, measured off and transported away in two subvolumes,

FIG. 5: shows a schematic representation of a microfluidic device in which a chamber is partially filled with a first medium,

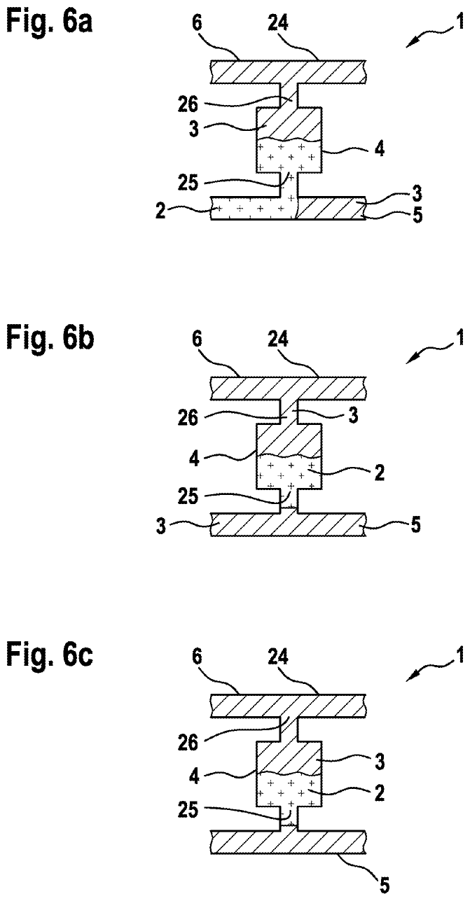

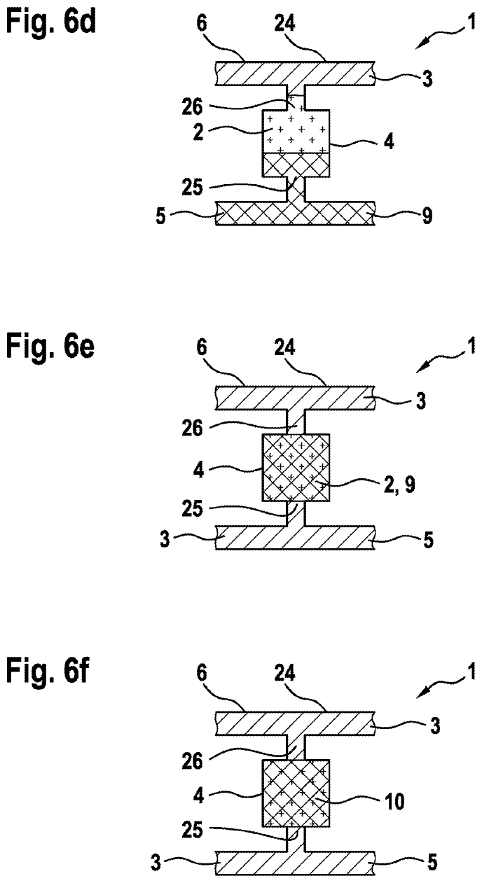

FIGS. 6a to 6f: show schematic representations of a microfluidic device in six successive points in time, wherein two first media are mixed together,

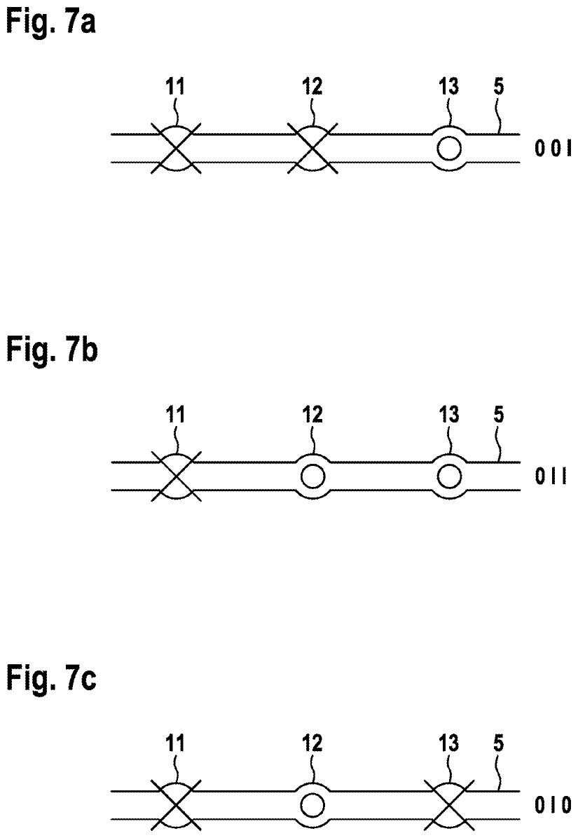

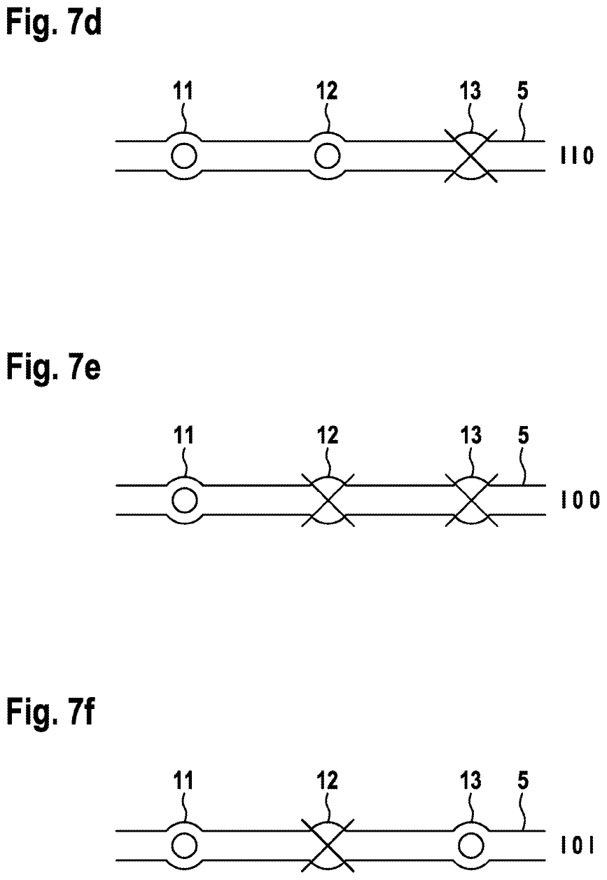

FIGS. 7a to 7f: show schematic representations of a microfluidic device having multiple valves which are switched differently in six successive points in time for peristaltic pumping,

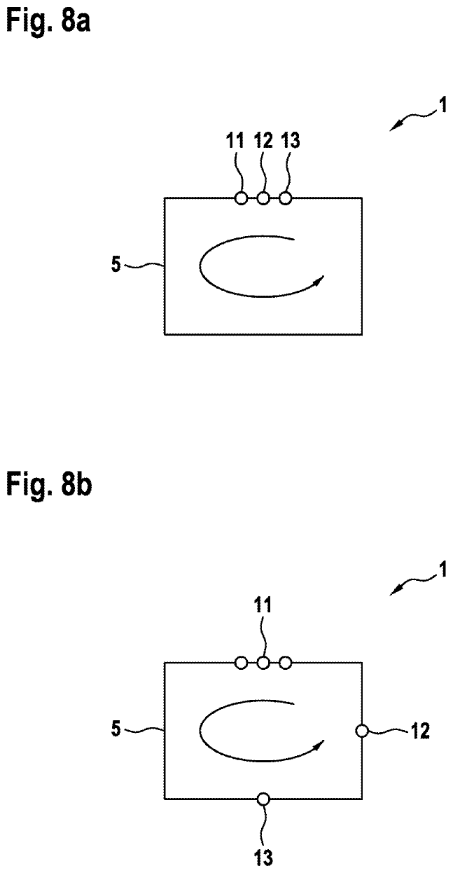

FIGS. 8a and 8b: show two schematic representations for peristaltic pumping,

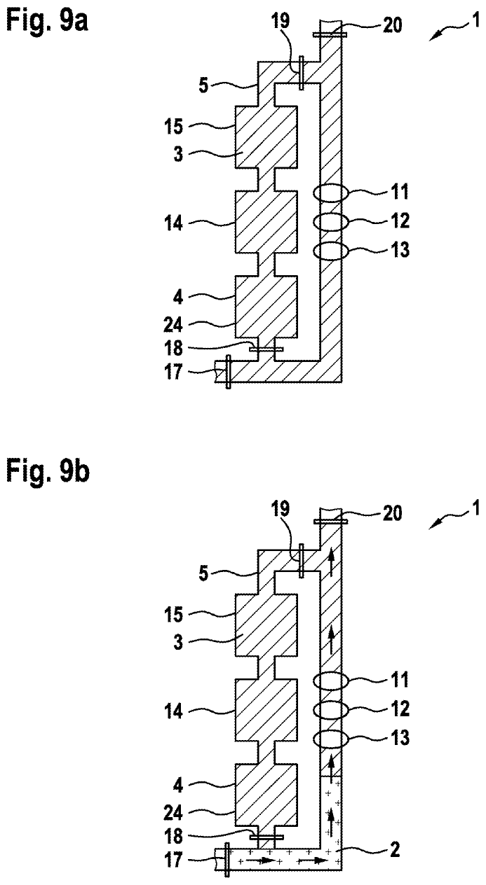

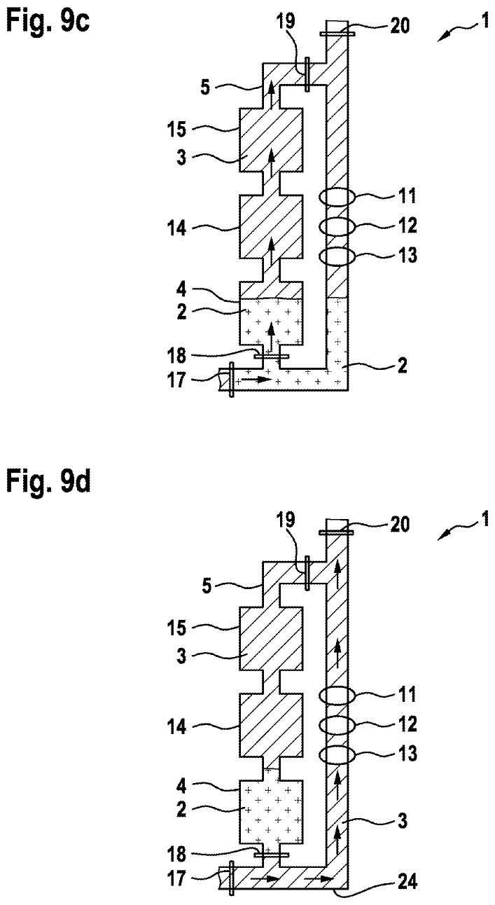

FIGS. 9a to 9d: show schematic representations of a microfluidic device in four successive points in time, wherein peristaltic pumping is carried out,

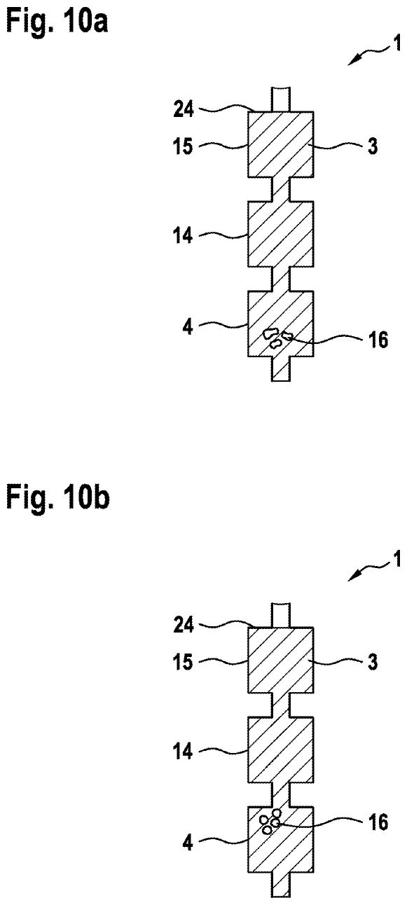

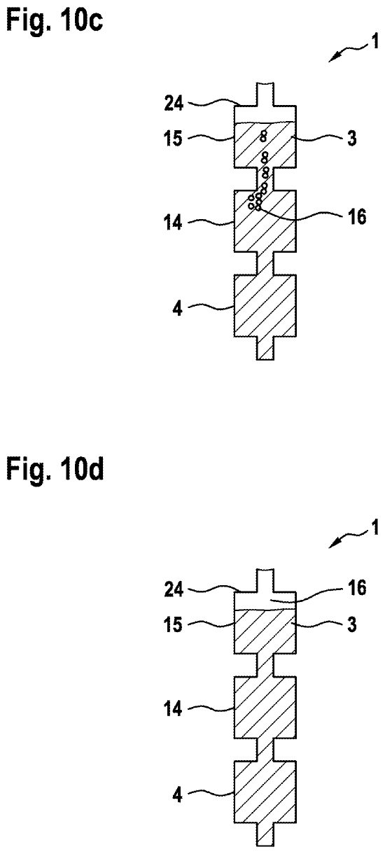

FIGS. 10a to 10d: show schematic representations of a microfluidic device in four successive points in time, wherein a gas pocket is removed,

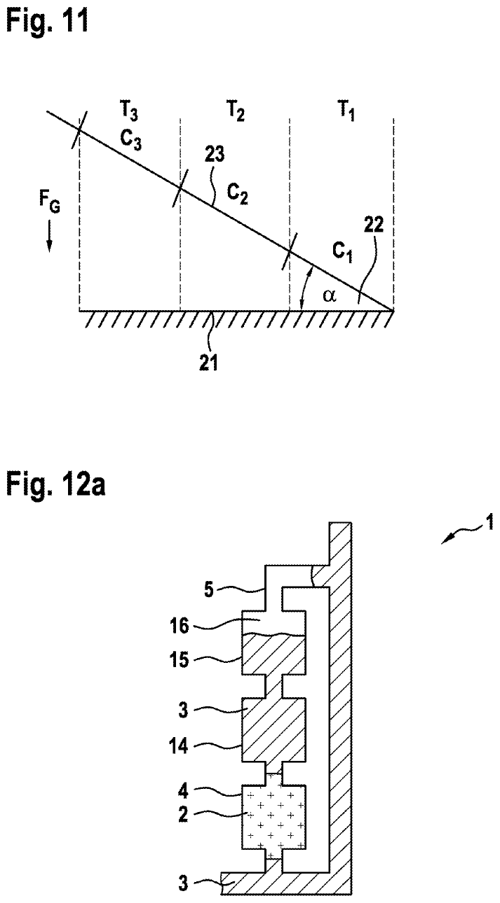

FIG. 11: shows schematic representations of a microfluidic device which has a tipped orientation,

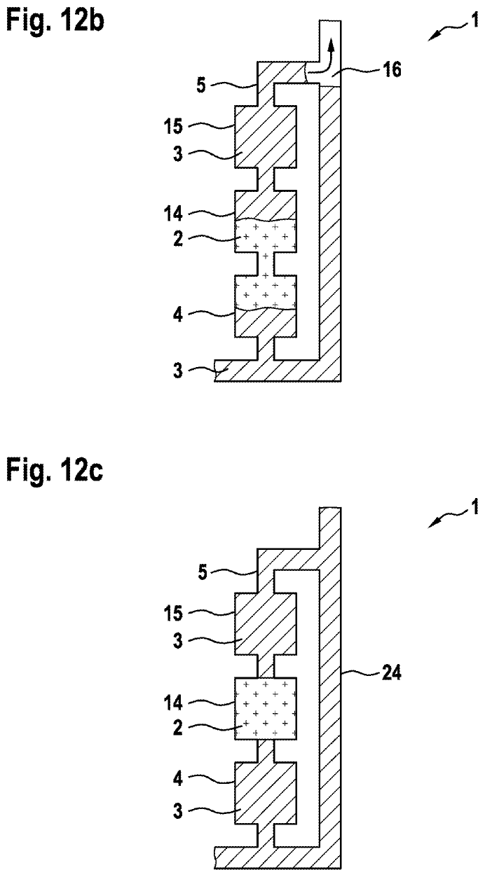

FIGS. 12a to 12c: show schematic representations of a microfluidic device in three successive points in time, wherein a gas pocket is removed,

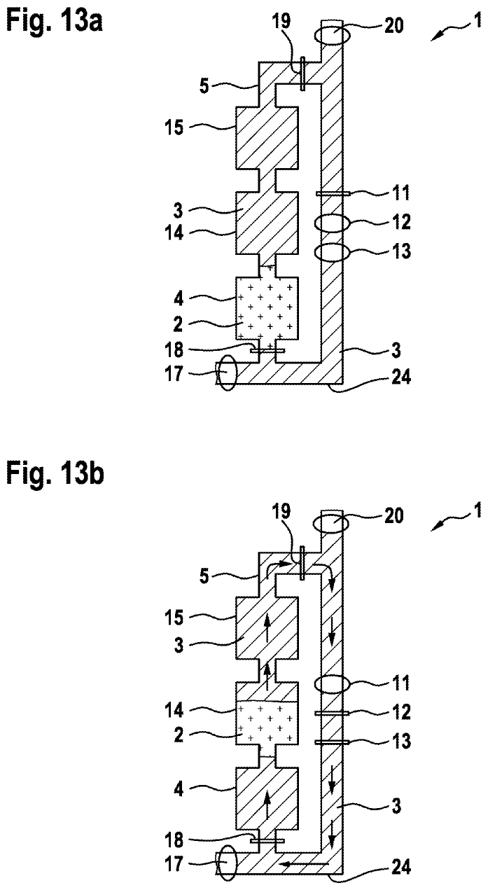

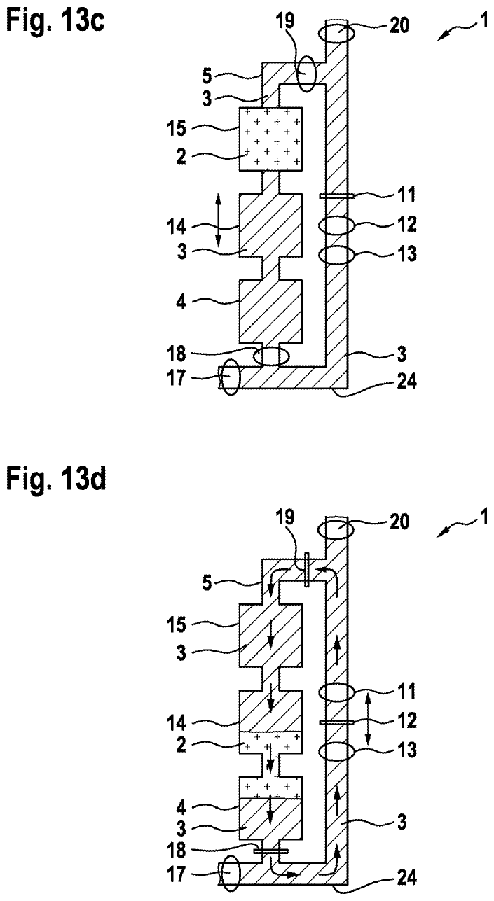

FIGS. 13a to 13d: show schematic representations of a microfluidic device in four successive points in time, wherein a shuttle PCR is carried out, and

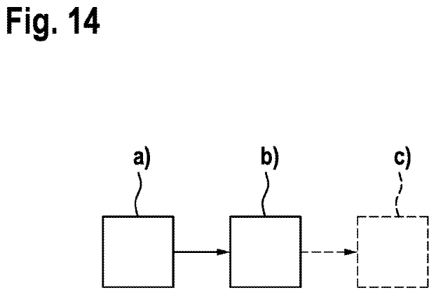

FIG. 14 shows a schematic representation of a method for operating a microfluidic device as per any of the exemplary embodiments from the previous figures.

FIGS. 1a to 1d show how, in a microfluidic device 1, a liquid phase as first medium 2 can be enclosed between two oil phases as second medium 3. In this case, the first medium 2 can especially be initially charged with a defined volume. The volume of the first medium 2 can be defined by the fixed and precisely producible geometry of the microfluidic device 1. In this form, it is therefore also possible to initially charge a defined concentration of the first medium 2, especially when an analyte is concerned.

To move the volume of the first medium 2 without dilution of the analyte therein by diffusion, the first medium 2 is enclosed among the second medium 3 (shown here by two oil phases). Since oil and water do not mix, dilution of the first medium 2 by diffusion does not take place. This can allow microfluidic transport of a defined volume of the first medium 2 through a first channel 5 or out of a first chamber 4 without any losses. The first chamber 4 is connected to a first channel 5 via a first port 25 and to a second channel 6 via a second port 26. The first medium 2 and the second medium 3 are surrounded by fluid boundaries 24.

In particular, the first medium 2 can be pre-stored in the first chamber 4 (FIG. 1a) and be transported therefrom into the first channel 5 through the first port 25 (FIG. 1b). In the further course of the first channel 5, the first medium 2 can be enclosed among the second medium 3 (FIG. 1c). FIG. 1d shows a different situation, in which the first medium 2 is enclosed in a first chamber 4 of the microfluidic device 1.

FIGS. 2a to 2c and 3a to 3e show two embodiments of a microfluidic device, by means of which a defined volume of an aqueous phase as first medium 2 can be brought between two inert oil phases as second medium 3.

In the embodiment as per FIGS. 2a to 2c, a first chamber 4 of known volume is arranged between a first channel 5 and a second channel 6 in parallel to the first channel 5. The first chamber 4 is connected to a first channel 5 via a first port 25 and to a second channel 6 via a second port 26. By means of appropriate fluid control (e.g., by use of valves or a pressure equalization system), the flow can be set into various directions and channel compositions (e.g., as a flow only in the channels 5, 6 or as a flow from the second channel 6 through the first chamber 4 into the first channel 5). In a first step, an aqueous phase as first medium 2 flows through the first chamber 4 (FIG. 2a) initially filled with a second medium 3 and the flow is stopped, with the result that the first chamber 4 is completely filled with the first medium 2 (FIG. 2b). The adjacent channels 5, 6, but not the first chamber 4, are subsequently flushed through with oil as second medium 3, with the result that the first chamber 4 is surrounded by two oil-filled channels 5, 6 (FIG. 2c). Now, what can be set is a flow from the second channel 6 through the first chamber 4 into the first channel 5. In this case, the three phases (i.e., the second medium 3 in the second channel 6, the first medium 2 in the first chamber 4 and the second medium 3 in the first channel 5) move in a laminar manner without mixing.

In a second embodiment as per FIGS. 3a to 3e, the first chamber 4 borders only on a first channel 5 (via a first port 25) and not on a first channel 5 and a second channel 6 as in the case of the first exemplary embodiment as per FIGS. 2a to 2c. Part of the first chamber 4 is open or (as shown) separated from the surroundings of the microfluidic device 1 by a gas-permeable membrane 7, meaning that air can be exchanged and/or pressure can be equalized between the first chamber 4 and the surroundings. The gas-permeable membrane 7 can especially be used as a sample input region, especially for applications in which only small quantities of a sample are introduced into the microfluidic device.

Moreover, FIG. 3a shows that a sample 8 (e.g., as a solid body or Lyobead) is present in the first chamber 4. To dissolve the sample 8 and/or to fill the first chamber 4, the first channel 5 is first filled with oil as second medium 3 in order to vent the entire system. The first chamber 4 is then filled with a liquid phase as first medium 2 (FIG. 3b). When the chamber is completely filled, oil as second medium 3 reflows through the first channel 5 and the first chamber 4 is thus completely closed off (FIG. 3c). The first medium 2 can then be re-enclosed among an oil phase as second medium 3 by pumping out the first chamber 4 via the first channel 5 (FIG. 3d) until the first chamber 4 is empty (FIG. 3e).

FIGS. 4a to 4e show a further exemplary embodiment of a microfluidic device 1, by means of which a defined volume of an aqueous phase as first medium 2 can be brought between two inert oil phases as second medium 3. Here, in contrast to the exemplary embodiment from FIGS. 2a to 2c, two subvolumes of the first medium 2 are successively removed from the first chamber 4. The starting point shown in FIG. 4a largely corresponds to the representation in FIG. 2c. As a result of a flow of the second medium 3 from the second channel 6 into the first channel 5, a portion of the first medium 2 is removed from the first chamber 4 (FIG. 4b). Thereafter, the second medium 3 reflows through the first channel 5 (FIG. 4c). Afterwards, the remaining portion of the first medium 2 is removed from the first chamber 4 (FIG. 4d). As can be seen in FIG. 4e, the first medium 2 is, in the further course of the first channel 5, present in two portions which are each enclosed by the second medium 3. FIGS. 4a to 4e therefore show that a two-phase system (having first medium 2 and second medium 3) can also be utilized for filling a microfluidic chamber with an aqueous phase (as first medium 2) only partially without any bubbles. The remaining volume of the chamber can be appropriately compensated for with an inert oil phase (as second medium 3). This can allow a dynamic adjustment of reaction volumes.

FIG. 5 shows one state from the exemplary embodiment from FIGS. 4a to 4e, in which the first chamber 4 is part-filled with the first medium 2 and part-filled with the second medium 3.

FIGS. 6a to 6f show an exemplary embodiment of a microfluidic device 1 in which two aqueous phase fluids (as a first medium 2 and a further first medium 9) are mixed. In this case, a first chamber 4 having a defined volume is half-filled with the first medium 2 (FIG. 6a). The first chamber 4 is connected to a first channel 5 via a first port 25 and to a second channel 6 via a second port 26. The supplying first channel 5 is then completely refilled with oil as second medium 3 (FIGS. 6b and 6c). After that, the first channel 5 is filled with the further first medium 9 (FIG. 6d). The first chamber 4 is then (preferably slowly) filled up with the further first medium 9, with the result that the entire first chamber 4 is filled with the two first media 2, 9 in the correct ratio. The first channel 5 is then refilled with the second medium 3, with the result that the two first media 2, 9 in the first chamber 4 are resurrounded by the second medium 3 in the channels 5, 6 (FIG. 6e). Owing to diffusion, the two first media 2, 9 in the first chamber 4 can mix rapidly, especially when the respective volumes are small. The result is shown in FIG. 6f, in which a mixture 10 of the two first media 2, 9 is present in the first chamber 4. The mixing process can be quickened by a temperature change. If desired, (bio)chemical reactions can also be carried out upon mixing. The combination of defined pumping processes and specified chamber geometries can allow mixing with different ratios between the first media 2, 9.

FIGS. 7a to 7f show how fluids can be moved with controlled speed in a linear or circular channel system of a microfluidic device by means of valves. Valves in the microfluidic device can be used not only for opening and closing microfluidic paths, but can also be used as peristaltic pumps. Along a desired microfluidic path (which can be linear or circular and is shown here as a linear first channel 5), what is formed by the valves as a result of serial opening and closing is a peristaltic pump. FIGS. 7a to 7f show the principle using the example of three valves 11, 12, 13 lying next to one another. Here, a circle indicates an open valve, whereas a cross indicates a closed valve. The valve status can also be represented digitally by, for example, a “1” signifying “open” and a “0” signifying “closed”. The valve status sequence 100 (FIG. 7e), 110 (FIG. 7d), 010 (FIG. 7c), 011 (FIG. 7b), 001 (FIG. 7a), 101 (FIG. 7f) generates a movement from left to right in the representation shown. The sequence 001 (FIG. 7a), 011 (FIG. 7b), 010 (FIG. 7c), 110 (FIG. 7d), 100 (FIG. 7e), 101 (FIG. 7f) generates a quasi-laminar flow from right to left.

Moreover, FIGS. 8a and 8b show that the valves 11, 12, 13 need not be placed next to one another, but can be arranged as desired along the first channel 5. This has the advantage that there is no need to place specific pump valves and that valves 11, 12, 13, which are present anyway, can be used instead. The flow rate can be set at a particular interval by means of a duration of a pause between successive valve positions.

FIGS. 9a to 9d show how the embodiment as per FIGS. 2a to 2c can be realized in a multichamber system (comprising a first chamber 4, a second chamber 14 and a third chamber 15) by peristaltic pumping. In a first step, the microfluidic device 1 is completely filled with an oil phase as second medium 3 (FIG. 9a). This need not necessarily be done by peristaltic pumping. When the microfluidic device 1 is filled, a fifth valve 18 and a sixth valve 19 between the chambers 4, 14, 15 and a first channel 5 are closed (FIG. 9b). A channel 5 arranged laterally in relation to the chambers 4, 14, 15 is then at least partially filled with the first medium 2. When this state is reached, the fifth valve 18 and the sixth valve 19 to the chambers 4, 14, 15 are opened and peristaltic pumping is carried out using the valves 11, 12, 13 until the first chamber 4 is completely filled with the first medium 2 (FIGS. 9c and 9d). The pump can be coupled to an optical feedback system, and be automatically stopped upon complete filling. Alternatively, just one trapped aqueous plug having the chamber volume can be introduced into the first chamber 4. When the first chamber 4 is completely filled, the fifth valve 18 to the first chamber 4 is closed and the first channel 5 is completely reflushed with the second medium 3 (by opening a fourth valve 17), with the result that only the first medium 2 remains in the first chamber 4 (FIG. 9d).

FIGS. 10a to 10d show how a two-phase system (having a first medium 2 and a second medium 3) can be used to remove gas pockets 16 in the first medium 2. In this structure, gas pockets 16 such as disruptive bubbles are removed by a temperature gradient. To this end, three microfluidic chambers 4, 14, 15 are arranged one after another and connected to one another by means of a respective small channel. Each of the three chambers 4, 14, 15 is individually heatable. The first chamber 4 is, then, set to the highest temperature and the second chamber 14 and the third chamber 15 to a lower temperature. At the same time, the heated gas bubbles 16 move from the first medium 2 into the colder second medium 3. When gravity is still acting along the chamber geometry (as shown), the gas pockets 16 rise to the very top owing to the lower density. What is therefore formed is a fluid system in which the first medium 2 is present in the first chamber 4, and the second chamber 14 and the third chamber 15 are filled with the second medium 3. In the third chamber 15, a gas phase can form. In the second medium 3, the temperature can then be raised again in order to ensure that the gas settles at the very top. The phase system can be shifted by one chamber in each case, with the first medium 2 then being situated for example in the second chamber 14 and the bubble-free second medium 3 in the third chamber 15. The bubble-containing first chamber 4 is then eliminated from the chamber system. The first chamber 4 can be closed or be refilled with the second medium 3.

FIG. 11 shows how an inclination of the microfluidic device 1 and thermally different zones can be utilized for the removal of gas pockets 16 as per FIGS. 10a to 10d. There is no need for gravity to act fully. Instead, an inclination (e.g., of 30°) is possible too. FIG. 11 shows a horizontal plane 21 and an angle 22 between the horizontal plane 21 and one side 23 of the microfluidic device 1 from FIGS. 10a to 10d. The three-chamber system shown in FIGS. 10 to 10d can be oriented such that the first chamber 4 containing the first medium 2 is at the bottom (c₁ in FIG. 11). Each chamber 4, 14, 15 is then in its own thermal zone (T₁, T₂, T₃). At the same time, what can be brought about gravity is that the light gas is shifted to the upper end of the third chamber 15 from the gas pocket 16 by heating (c₃ in FIG. 11).

FIGS. 12a to 12c show an exemplary embodiment in which a gas pocket 16 as for FIGS. 10a to 10d and 11 can be removed. In FIGS. 12a to 12c, it is assumed that the gas pocket 16 has been removed from the first medium 2 as per the method as per FIGS. 10a to 10d with the aid of the conditions from FIG. 11 (FIG. 12a). To now remove the gas pocket 16 from the microfluidic device 1, a second medium 3 is subsequently shifted from the bottom through the three chambers 4, 14, 15 until the first medium 2 has been completely shifted from the first chamber 4 into the second chamber 14. At the same time, the gas pocket 16 is displaced from the third chamber 15 into the first channel 5 (FIG. 12b). Thereafter, the gas can be discharged from the microfluidic device 1 as a result of subsequent shifting of second medium 3 through the first channel 5 (but not through the chambers 4, 14, 15), with the result that a completely bubble-free microfluidic device 1 remains (FIG. 12c).

FIGS. 13a to 13d show how a bubble-free shuttle PCR can be carried out using a two-phase system and the combination of the above-described removal of a gas pocket 16. In a shuttle PCR, there is, in contrast to a thermal cycler, no dynamic change in the temperature of heaters, but there is shifting of the reaction mixture between different heaters having constant temperatures. To carry out a shuttle PCR, the microfluidic device 1 can be designed especially as per FIGS. 7a to 7f, 10a to 10d and 11. In the arrangement of three chambers 4, 14, 15 and a first channel 5, what are preferably envisaged are three valves 11, 12, 13, which form a peristaltic pump. The PCR reaction mixture (as first medium 2) is preferably initially charged in the first chamber 4 without any bubbles, whereas the second chamber 14 and the third chamber 15 and also the first channel 5 are filled with the second medium 3 (FIG. 13a). The chambers 4, 14, 15 are set to the appropriate temperatures required for the PCR. The first medium 2 as PCR mixture can then be held in the appropriate chambers 4, 14, 15 for respectively intended times before it is pumped peristaltically into the next of the chambers 4, 14, 15 (FIGS. 13b to 13d). What is shown in particular is how back-and-forth movement (shuttling) can be carried out between two temperatures. By reversing the pumping frequency, as described on the basis of FIGS. 7a to 7f, it is possible to pump in both directions.

FIG. 14 shows a method for operating a microfluidic device 1 as per any of the exemplary embodiments from the previous figures. The method comprises the following steps:
a) providing at least one first medium 2, 9 at a first site of the microfluidic device 1,
b) transporting the at least one first medium 2, 9 from the first site to a second site of the microfluidic device 1, wherein the at least one first medium 2, 9 is surrounded by at least one second medium 3 such that the at least one first medium 2, 9 is adjacent only to the at least one second medium 3 and to fluid boundaries 24 of the microfluidic device 1 or only to the at least one second medium 3, and wherein the at least one first medium 2, 9 and the at least one second medium 3 are not miscible with one another.

Furthermore, the method preferably comprises the following method step (drawn in with dashed lines), which is carried out before, during or after step b):
c) removing at least one gas pocket 16.

In the example of FIG. 14, step c) is carried out after step b).

1. A method for operating a microfluidic device, comprising:
providing at least one first medium at a first site of the microfluidic device,
transporting the at least one first medium from the first site to a second site of the microfluidic device,
wherein the at least one first medium is surrounded by at least one second medium such that the at least one first medium is adjacent only to the at least one second medium and to fluid boundaries of the microfluidic device or only to the at least one second medium, and
wherein the at least one first medium and the at least one second medium are not miscible with one another.

2. The method as claimed in claim 1, wherein:
the providing of the at least one first medium includes providing a specifiable volume of the at least one first medium in a chamber of the microfluidic device,
the chamber has at least one port, and
the specifiable volume of the at least one first medium in the chamber is separated and measured off by the at least one second medium outside the chamber flowing around the at least one port.

3. The method as claimed in claim 1, wherein:
the providing of the at least one first medium includes providing multiple first media, and
the transporting of the at least one first medium includes transporting the multiple first media such that the multiple first media are mixed in a chamber of the microfluidic device.

4. The method as claimed in claim 1, wherein the transporting of the at least one first medium includes transporting at least one portion of the at least one first medium and/or at least one portion of the at least one second medium at least intermittently by peristaltic pumping.

5. The method as claimed in claim 1, further comprising:
removing at least one gas pocket before, during, or after the transporting of the at least one first medium.

6. The method as claimed in claim 5, wherein the microfluidic device is, at least during part of the removing of the at least one gas pocket, oriented such that one side of a section from which the at least one gas pocket is removed is tilted with respect to a horizontal plane.

7. The method as claimed in claim 5, wherein the removing of the at least one gas pocket includes changing a temperature of a fluid in which the at least one gas pocket is enclosed.

8. The method as claimed in claim 5, wherein the removing of the at least one gas pocket includes removing the at least one gas pocket by transport of the at least one first medium and/or the at least one second medium.

9. The method as claimed in claim 1, wherein:
a shuttle polymerase chain reaction is carried out, and
the at least one first medium is a reaction medium of the shuttle polymerase chain reaction.

10. A microfluidic device comprising:
a first site; and
a second site,
wherein the microfluidic device is configured to be provided at least one first medium at the first site and to transport the at least one first medium from the first site to the second site, the at least one first medium being surrounded by at least one second medium such that the at least one first medium is adjacent only to the at least one second medium and to fluid boundaries of the microfluidic device or only to the at least one second medium, and the at least one first medium and the at least one second medium are not miscible with one another.
